(19) United States
(12) Patent Application Publication
(10) Pub. No.: US 2004/0084972 A1
(43) Pub. Date: May 6, 2004

(54) Wireless remote time socket apparatus

(76) Inventor: Linsong Weng, Chu-Pei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/283,275

(22) Filed: Oct. 30, 2002

(51) Int. Cl. H01H 3/26

(52) U.S. Cl. 307/140

(57) ABSTRACT

The present invention is to provide a wireless remote time socket apparatus. The wireless remote time socket apparatus comprises a wireless remote time socket module and a remote control module for emitting the remote signals to the wireless remote time socket module. The wireless remote time socket module includes a central process unit to perform comparing and confirming the remote signal of a wireless receiving module with a storage data in the memory. After confirming correctly, the central process unit is transferring a control signal to a power control electric circuit to control whether a power source of the AC power input end is to timely provide to the domestic socket according to the control signal, wherein the domestic socket is connecting with the power control electric circuit and the AC power input end. Besides, the present invention further includes another power supply electric circuit to rectify and transform the AC power to a DC power for providing a required power of mentioned elements. The present invention provides with the effect of constantly controlling the socket power, promptly turning on, shutting down, and delaying shutting down the electric equipment in the far-end.

### BACKGROUND OF THE INVENTION

1. Field of the Invention

The present invention generally relates to a socket device, and more particularly relates to provide a wireless remote time socket apparatus which is controlled via a wireless remote method for constantly controlling the socket power, promptly turning on, shutting down, and delaying shutting down the electric equipment in the far-end.

2. Description of the Prior Art

With the enhancement of the life standard, people commonly have respect to the quality and convenience of the life, so the domestic electric equipments are continuously developed to replace the old product and the amount is suddenly increasing. Usually, each of electric equipments is arranged a plug to insert into a socket, so the electric equipments can get the power source from the socket for operating the electric equipments. Hence, socket for providing the power supply is very important for the current society. Almost each of the rooms arrange with the socket, especially in some specific places, the require of remote the socket on time should be necessary, such as the time remote of the watering system, or the automatically time cutting down power device of the remote opening door system. There are many applications in the usual life.

However, no matter the socket is fixed on the wall or the socket is moveable type extended socket, the use of the current socket needs people to directly pull out or insert the plug in the socket by oneself so as to control the on/off of the power, and the operation is more inconvenient and it should be noticed that if your hand is moist, you should not only pull the wire and should pull the plug portion when you pull out or insert the plug to avoid the damage of electric wire sparkling causing from the damage of the connecting wire of the plug. Besides, because the power use of the electric equipment is dividing into 110 Voltage and 220 Voltage, if people not understanding the socket structure, it may insert the plug of 110 Voltage into the socket of 220 Voltage so as the electric equipment may immediately burnout because of the too high voltage.

Obviously, the main spirit of the present invention is to provide people the convenience of flexibly controlling the power in the socket and simultaneously remote to shutting down the turning on power switch on time, and the present invention not only apply for the normal home life, but also can help the move obstacle user to control the power of each socket in the house by himself, and then to provide a wireless remote time socket apparatus which can remote to time control the on/off switch of the power so as to achieve the most appropriate control the home electric power and to fit in with the require of the life convenience for the people.

### SUMMARY OF THE INVENTION

The primary object of the present invention is to provide a wireless remote time socket apparatus which is utilizing the remote control module matching with a wireless time socket module to time control whether the AC power is inputted into the socket so as to control the electric equipments in the far-end, wherein the electric equipment s are connecting on the socket to achieve the effect of time controlling the power source of the electric equipments

Another object of the invention is to provide a wireless remote time socket apparatus that the users can use the telephone network to control the power source of the socket.

A further object of the invention is to provide a wireless remote time socket apparatus, which can be controlled through the computer or the Internet to constantly control the socket power for promptly turning on, shutting down, and delaying shutting down in the far-end.

A furthermore object of the invention is to provide a wireless remote time socket apparatus which is space limitation free, used conveniently, and flexible. The wireless remote time socket apparatus can time control the power supply of the domestic electric equipments in the far-end and not only provide the more space for the user but can prevent the inconvenience and the damage causing from cutting off the power supply by pulling out the plug.

In order to achieve previous objects, the present invention provides a wireless remote time socket apparatus. The wireless remote time socket apparatus comprises a wireless remote time socket module and a remote control module. The wireless remote time socket module is arranged a central process unit, wherein the central process unit is respectively connecting with a wireless receiving module, a memory, and at least a power control electric circuit, wherein each the power control electric circuit is connecting with a socket and an AC power input end so as to use the wireless receiving module to receive a remote signal and then to transfer the remote signal to the central process unit, and the central process unit is to perform comparing and confirming the remote signal with a storage data in the memory and then to transfer control signal to the power control electric circuit, and then the power control electric circuit is to control whether a power source of the AC power input end is to timely provide to the socket in accordance with the control signal, and further comprises another power supply electric circuit connected with the AC power input end to rectify and transform the AC power to a DC power for providing a required power of mentioned elements. The remote control module is for emitting different the remote signals to the wireless remote time socket module so as to far-end time control the input or cutting down of the power of the wireless remote time socket module.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a block chart of the structure of the wireless remote time socket module, in accordance with the present invention;

FIG. 2 is a block chart of the structure of the handed remote control module, in accordance with the present invention; and

FIG. 3 a block chart of the structure of the telephone far-end remote control module, in accordance with the present invention.

### DESCRIPTION OF THE PREFERRED EMBODIMENT

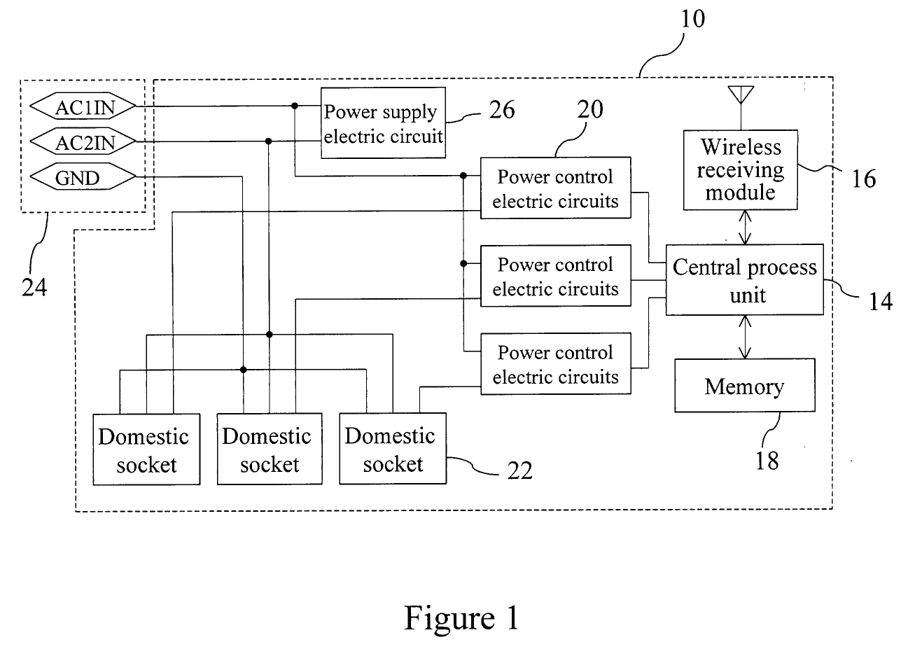

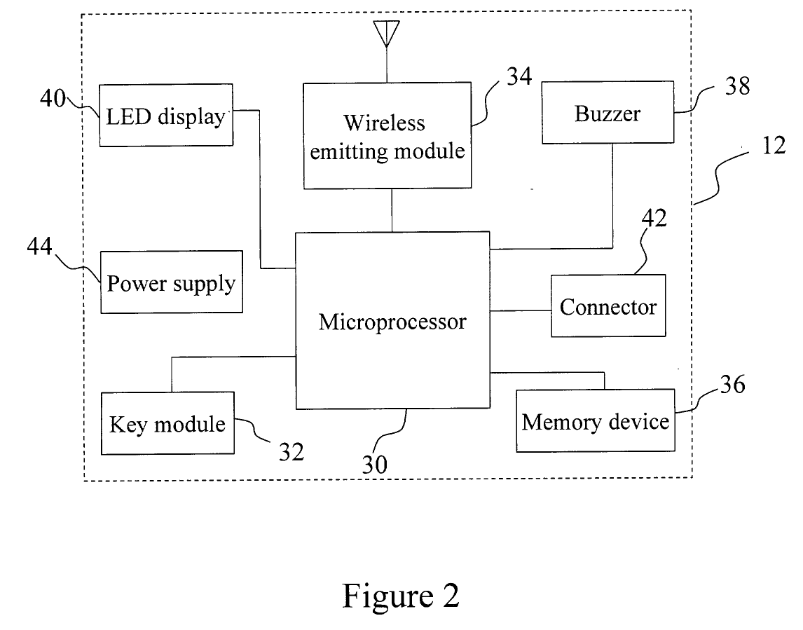

Referring to the FIG. 1 and the FIG. 2, the present invention includes a wireless remote time socket module 10 and a handed type remote controller module 12. In the wireless remote time socket module 10, a central process unit 14 for controlling whole action of the socket module is arranged therein, wherein the central process unit 14 is respectively connecting with a wireless receiving module 16, a memory 18, and three power control electric circuits 20. Each of power control electric circuits 20 includes a relay and a time controller (not shown in the figure). The time controller is set the delayed time by the program of the central process unit 14. Each of power control electric circuits 20 is respectively connecting with a domestic socket 22 and connecting to a collective AC power input end 24, and further includes a power supply electric circuit 26 to connect with the AC power input end 24 so as to rectify and conform the AC power to the DC power for providing the required electric power to the mentioned elements.

In the present invention, the wireless remote time socket module 10 is utilizing the wireless receiving module 16 to receive the built-in internal code emitting from the handed type remote controller module 12 and to store in the memory 18 for the use the central process unit 14 to learn and to identify, and then the wireless receiving module 16 receives the remote signal emitted from the handed type remote controller module 12 to transfer to the central process unit 14. Then, the central process unit 14 will perform the comparison in accordance with the internal code of the handed type remote controller module 12 stored in the memory 18, and simultaneously identify if the remote signal is corrective with the stored data in the memory 18. After correctly identifying, the central process unit transfers a control signal to one of the power control electric circuits 20. The control electric circuit 20 is to control the on/off of the power of AC power input end 24 to the corresponding domestic socket 22 in accordance with the control signal, so as to utilize the time controller in the power control electric circuit 20 to automatically on/off on time. Wherein, the wireless remote time socket module 10 can be manufactured as a fixed type socket module which cab insert into a wall surface, a desk surface, or a desk wall, or as a movable type extended socket module.

As mentioned above, the handed type remote controller module 12 includes a microprocessor 30, which is respectively connecting with a key module 32, a wireless emitting module 34, a memory device 36, a buzzer 38, a LED (light emitting diodes) display 40, and a connector 42. The microprocessor 30 is used for controlling the operation of the whole handed type remote controller module 12 and built-in a remote learning program and remote program so as to receive and learn the typed-in order from the key module 32 and the internal code of the wireless remote time socket module 10, and then to store in the memory device 36. The microprocessor 30 receives the typed-in order from the key module 32, and after identifying the typed-in order, the order is conformed to a remote signal transferring to the wireless emitting module 34 to emit the remote signal to the wireless remote time socket module 10. As performing the remote, the buzzer 38 will buzz to confirm the actual input status, and the LED display 40 will also shine to present the control status of the whole apparatus. The connector 42 connecting with the microprocessor 30 is usually using the RS-232C joint for the handed type remote controller module 12 to connect to other external digital system, such as the computer system. By using the connection of the computer and the Internet, the present invention can achieve the effect of far-end controlling the wireless remote time socket module 10. There is further having a power supply 44, such as the electric cell, for providing the required electric power for the action of mentioned elements.

As performing the far-end control of the socket power, if the wireless remote time socket module 10 receives the remote signal emitted from the handed type remote controller module 12, the power control electric circuit 20 in the wireless remote time socket module 10 will generate the action of promptly turning on, shutting down, or delaying shutting down to decide the status of immediately conductive, immediately broken circuit, or delayed broken circuit of the AC power of the domestic socket 22 so as the domestic socket 22 can promptly turning on, promptly shutting down, or delayed shutting down.

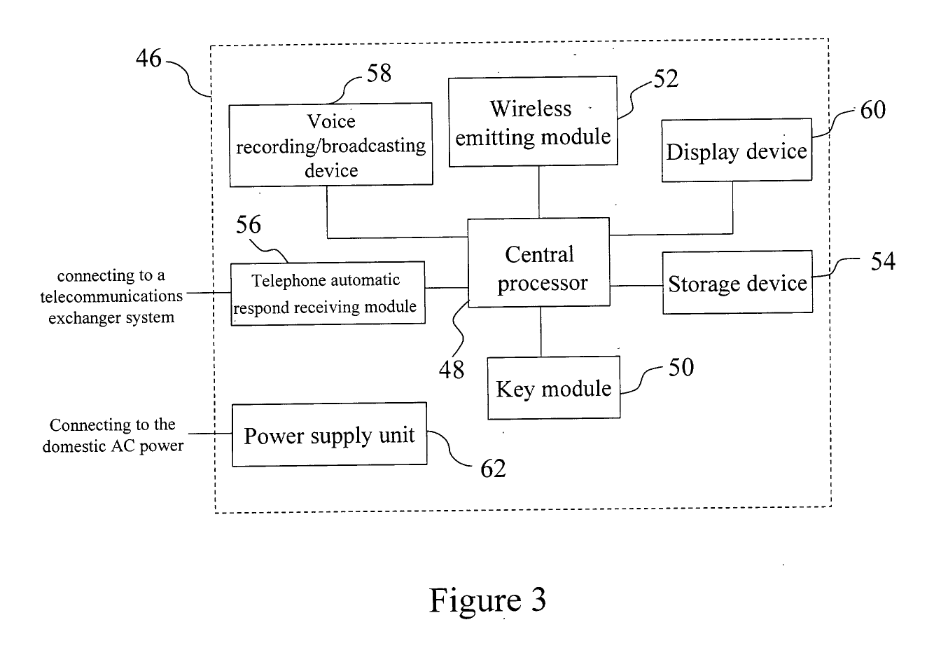

The present invention not only can far-end control the wireless remote time socket module 10 via the mentioned handed type remote controller module 12, but also can accept the control of the telephone far-end remote control module 46, such as shown in the FIG. 3. The telephone far-end remote control module 46 includes a central processor 48, which is respectively connecting with a key module 50, a wireless emitting module 52, a storage device 54, a telephone automatic respond receiving module 56, a voice recording/broadcasting device 58, and a display device 60. The central processor 48 receives an internal code and a typed-in order from the key module 50. The central processor 48 simultaneously requests the display device 60 to present the internal code and to store in the storage device 54. The telephone automatic respond/receiving module 56 is connecting to a telecommunications exchanger system for user to through the telephone line via the telephone automatic respond receiving module 56 to transfer the order into the telephone far-end remote control module 46, and then to use the voice recording/broadcasting device 58 therein to provide the operation via voice for the user. So, the user can use the voice suggestion of the voice recording/broadcasting device 58, and the present invention can achieve the effect of easy operation. Then, the telephone automatic respond/receiving module 56 transfers the received telephone tone signal to the central processor 48, and after the central processor 48 identifying, the telephone tone signal is transformed to a remote signal transferring to the wireless emitting module 52 for emitting the remote signal to the wireless remote time socket module 10, and further includes a power supply unit 62 connected with the domestic AC power to provide a required power of mentioned elements.

The present invention utilizes a wireless remote time socket module arranged the power control electric circuit and the digital electric circuit therein to match a wireless remote time control module to embody the present invention and to far-end control the on/off of the socket power on time. The wireless remote time socket apparatus is space limitation free, used conveniently, and flexible. The wireless remote time socket apparatus can time control the power supply of the domestic electric equipments in the far-end and not only provide the more space for the user but can prevent the inconvenience and the damage causing from cutting off the power supply by pulling out the plug. In the present invention, the users can use the telephone network to control the power source of the socket so as to achieve the most appropriate control the home electric power and to fit in with the require of the life convenience for the people.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A wireless remote time socket apparatus comprising:
a wireless remote time socket module arranged a central process unit therein, wherein said central process unit is respectively connecting with a wireless receiving module, a memory, and at least a power control electric circuit, wherein each said power control electric circuit is connecting with a socket and an AC power input end so as to use said wireless receiving module to receive a remote signal and then to transfer said remote signal to said central process unit, and said central process unit is to perform comparing and confirming said remote signal with a storage data in said memory and then to transfer a control signal to said power control electric circuit, and then said power control electric circuit is to control whether a power source of said AC power input end is to timely provide to said socket in accordance with said control signal, and further comprises another power supply electric circuit connected with said AC power input end to rectify and transform said AC power to a DC power for providing a required power of mentioned elements; and
a remote control module emitting different said remote signals to said wireless remote time socket module.

2. The wireless remote time socket apparatus according to claim 1, wherein said power control electric circuit includes a relay.

3. The wireless remote time socket apparatus said according to claim 1, wherein said power control electric circuit further includes a time remote controller.

4. The wireless remote time socket apparatus according to claim 1, wherein said wireless remote time socket module is an insert-able fixed type socket module.

5. The wireless remote time socket apparatus according to claim 1, wherein said wireless remote time socket module is a moveable extended type socket module.

6. The wireless remote time socket apparatus according to claim 1, wherein said wireless remote time socket module is selected from the group of a handed remote control module and a telephone far-end remote control module.

7. The wireless remote time socket apparatus according to claim 6, wherein said handed remote control module includes a microprocessor which is respectively connecting with a key module, a wireless emitting module, and a memory device, wherein said microprocessor is receiving a typed-in order from said key module and store said order into said memory device so as to identify said order via said microprocessor and then to transform said order into a remote signal transferring to said wireless emitting module for emitting said remote signal to said wireless remote time socket module to remote said socket apparatus to promptly turning on or delaying shutting down, and further includes a power supply device to provide a required power of mentioned elements.

8. The wireless remote time socket apparatus according to claim 7, wherein said microprocessor is further connecting with a buzzer

9. The wireless remote time socket apparatus according to claim 7, wherein said microprocessor is further connecting with a display device.

10. The wireless remote time socket apparatus according to claim 7, wherein said microprocessor is further connecting with a connector.

11. The wireless remote time socket apparatus according to claim 6, wherein said telephone far-end remote control module includes a central processor which is respectively connecting with a key module, a wireless emitting module, a storage device, and a telephone automatically responding/receiving module, wherein said central processor is receiving a typed-in order from said key module and store said order into said storage device, and said central processor is to identify said input order from said telephone automatically responding/receiving module and then to transform said order into a remote signal transferring to said wireless emitting module for emitting said remote signal to said wireless remote time socket module, and further includes a power supply device to provide a required power of mentioned elements.

12. The wireless remote time socket apparatus according to claim 11, wherein said central processor is further connecting with a display device.

13. The wireless remote time socket apparatus according to claim 11, wherein said central processor is further connecting with a voice recording/broadcasting device.
